(19) United States
(12) Patent Application Publication
(10) Pub. No.: US 2003/0056084 A1
(43) Pub. Date: Mar. 20, 2003

(54) Object orientated heterogeneous multi-processor platform

(76) Inventors: Christopher John Holgate, Watford (GB); Gianni Michele Nannetti, Lower Stondon (GB); Hugh Alexander Prosser Eland, Wembley (GB); Paul David Onions, Tooting (GB); Franklin Charles Wray, Letchworth (GB); Tirumala Rao Parvataneni, Woking (GB)

Correspondence Address: SHERIDAN ROSS PC, 1560 BROADWAY, SUITE 1200, DENVER, CO, 80202

(21) Appl. No.: 10/223,778

(22) Filed: Aug. 19, 2002

(30) Foreign Application Priority Data
Aug. 21, 2001 (GB) GB 0120304.1

(51) Int. Cl. G06F 9/00; G06F 9/44; G06F 15/00; G06F 15/76

(52) U.S. Cl. 712/29; 709/106; 709/315

(57) ABSTRACT

There is provided an object orientated heterogeneous multi-processor architecture comprising a plurality of execution units amongst which object methods are distributed, a run-time support, a shared memory for storing object data and which is accessible by the execution units and by the run-time support, and an invocation network for carrying method invocation messages between execution units and/or between the run-time support. Object based source code is distributable across a variable number of the execution units. The invocation network is logically distinct from any mechanism for accessing the object data stored in the shared memory. Also provided are methods of operating the heterogeneous multi-processor architecture and of managing communications in an object orientated program execution environment.

### FIELD OF THE INVENTION

The present invention relates to object-orientated processor platforms, and in particular to an apparatus and method of implementing object-orientated systems using heterogeneous execution units with access to shared memory.

### BACKGROUND OF THE INVENTION

The design of electronic systems, particularly in the communications field, is becoming more and more complex. The standards are fast moving and the functionality required of a system is no longer just implemented as hardware, but rather as an interaction of multiple software and hardware components. The blending of the software and hardware design flows is starting to drive many of the software programming techniques, in particular object orientated design, into the hardware implementation process.

The basic conceptual component of any object orientated system is an object. This has the form shown in FIG. 1 which depicts a commonly used object-orientated system consisting of some object data 2, and a number of methods 3 which operate upon that data to update it, transform it or extract it. The methods applicable to an object define its class, with all objects that share an identical set of methods belonging to the same class. A class definition includes two special types of method which act as object constructors and object destructors. Object constructors are methods which can create new objects of a particular class, either when invoked by another object method or when triggered by some external stimulus such as the arrival of data on an input port. Object destructors perform the opposite function, destroying a specified object when invoked.

In order for multiple objects to interact as a system, an object runtime environment 6 is required. This provides a mechanism 7, 13 for invoking object methods via the passing of messages between objects. An object method 3 is invoked whenever a suitable ‘call’ message is sent to that particular method. The invoked method may then generate a ‘return’ message which informs the invoker of that method, of the result of the method invocation. Also present in the runtime environment is a synchronisation facility 8 which can be used to ensure that two conflicting methods are not invoked on the same object simultaneously. A final essential part of the runtime environment is a mechanism 9 which supports the creation and deletion of objects by allocating and deallocating the resources required by the object.

The way in which the features of an object orientated system are mapped onto a typical software implementation is also shown in FIG. 1. For each distinct method which may be applied to an object, a sequence of instructions 16 are stored in the processor's memory 10. For each object which is a part of the system at any given time, an area of the processor's memory 14 is allocated for the storing of the object data. The object runtime environment 6 is provided as a sequence of instructions which implement the operating system and additional language specific runtime features. In the simplest case, message passing 7 and synchronisation 8 are combined using a single threaded call and return mechanism. This ensures that only one method is being executed by the processor at any given time. The creation and deletion of objects is handled by a set of memory management routines 15 which control the allocation of memory, assigning data areas to objects as they are created and recovering the data areas of objects as they are destroyed.

It is possible to implement object orientated software systems on multiple processors using symmetric multiprocessing (SMP), where multiple identical processors 11 access the same shared memory via a shared bus, crosspoint switch or other similar mechanism. This preserves the model shown in FIG. 1 for a single processor system with the additional requirement that explicit synchronisation capabilities be provided between the processors. In this case, synchronisation becomes an additional operating system task compromising efficiency.

Symmetric multiprocessing scales poorly when more processors are added to the system because in addition to accessing object data in the shared memory, the processors must also fetch executable code from the same shared memory for operating system routines and method invocations. A more significant problem occurs in systems where a subset of the methods to be invoked cannot be efficiently implemented in software. In this case, the conventional way to introduce hardware acceleration without breaking either the object orientated system design or the symmetric multiprocessing model is to effectively extend the instruction sets of the processors being used—an approach which is not always practical.

An alternative approach to implementing object orientated software systems on multiple processors uses distributed processing as illustrated in FIG. 2. An example of a processor designed specifically for distributed processing applications would be the Inmos™ Transputer™.

In an object orientated distributed processing system there are multiple processors 20a, 20b, 20c, each with its own local memory area 21a, 21b, 21c for storing object data 22a, 22b, 22c and executable code for method definitions 23a, 23b, 23c with runtime support 24a, 24b, 24c. These processors are connected together using a relatively low bandwidth message bus or switch 25, since all the fast processor to memory accesses are performed locally. Method ‘call’ messages are passed between the processors via the messaging system in order to invoke the execution of the methods stored in local memory. These methods act on locally stored object data before optionally sending a ‘return’ message to the invoker.

The runtime support for message passing and synchronisation are implicit in the message passing infrastructure of the distributed system, with the runtime support present for each processor providing localised management of resources for object creation and deletion.

Distributed multiprocessing can scale well for any systems where object data can be statically assigned to one particular processor. However, the implication of this is that the types of methods which may be applied to that object are restricted by the capabilities of that processing unit which hosts the object. It is impractical to implement some methods on a flexible processor and others on a separate hardware accelerator, since the object data would need to be copied around the system in a non-object orientated manner.

If hardware acceleration for specific methods is required, the conventional way to achieve this without breaking either the object orientated system design or the distributed processing model is to effectively extend the instruction sets of the processors being used.

In multiprocessor systems one of the major areas of potential difficulty is writing code in such a way as to make use of the available processing resources. With heterogeneous systems this problem has been particularly acute, and often separate code has been written for individual processing units. This makes understanding, maintaining and, most importantly, scaling the code base as processors are added, significantly more difficult.

With SMP systems this problem is significantly reduced as a single set of source files is used, but SMP architectures do not typically scale well in terms of performance above four processing units.

It is a general objective of the present invention to overcome or significantly mitigate one or more of the aforementioned problems.

### SUMMARY OF THE INVENTION

According to a first aspect of the invention there is provided an object orientated heterogeneous multiprocessor architecture comprising: a plurality of execution units amongst which object methods are distributed; a runtime support; a shared memory for storing object data and which is accessible by the execution units and by the runtime support; and an invocation network for carrying method invocation messages between execution units and between the runtime support, and any combination thereof, whereby object based source code is distributable across a variable number of execution units, and the invocation network is logically distinct from any mechanism for accessing the object data stored in the shared memory.

In a preferred embodiment the architecture is implemented on a single integrated circuit or chip.

An advantage of this architecture over conventional SMP systems is that a larger number of execution units can be supported. Thus, for a given number of parallel executing threads, fewer threads need to be assigned to each of the execution units. The result is that the overall overhead associated with context switching between threads is reduced and as the number of threads increases, the performance improvement over SMP systems becomes more pronounced.

Another advantage of the disclosed architecture is the efficient use of message passing resources as raw object data is not passed over the invocation network, as is the case with the conventional distributed multiprocessing approach.

The disclosed architecture is advantageous as the unified nature of the runtime support enables the heterogeneous execution units to communicate together in a single system using the standardised method invocation and shared memory interfaces.

According to a second aspect of the invention there is provided a method of operating an object orientated heterogeneous multiprocessor architecture comprising the steps of: concurrently activating a plurality of threads under the control of an application program or as a response to external events; and executing each of the plurality of threads by sequentially invoking a number of different object methods on a plurality of different execution units via an invocation network.

In a preferred embodiment, the step of sequentially invoking a plurality of object methods comprises: accepting object method invocations from the invocation network; and executing the object methods specified by the object method invocations as prescribed by the programming and configuration of the execution units.

In a further embodiment, the step of executing the object methods comprises: modifying, transforming or extracting object data held in the shared memory area.

According to a third aspect of the invention there is provided a method of managing communication in an object orientated program execution environment comprising the steps of: generating method invocations using execution units; passing the method invocations over an invocation network; and nesting method invocations between multiple execution units via a method invocation interface.

According to a fourth aspect of the invention there is provided a method of invoking an object method comprising the steps of: passing a control message requesting the invocation of an object method on an object from a first execution unit to a second execution unit using an invocation network; and executing the control message to invoke the object method on the object using the second execution unit.

According to a fifth aspect of the present invention there is provided an invocation network capable of being used with the architecture of the first aspect of the invention described above, comprising: a messaging bus or switch for conveying control messages issued by execution units; and a plurality of method invocation interfaces for connecting the messaging bus to the execution units.

According to a sixth aspect of the present invention there is provided a runtime support capable of being used with the architecture of the first aspect of the invention described above, and having at least one object comprising: at least one memory allocation unit, wherein the runtime support is provided as a collection of resources in communication with other hardware and software objects via an invocation network. Preferably, the or each object further comprises one or more of: at least one counter, at least one event timer, and at least one semaphore.

According to a seventh aspect of the present invention there is provided an input/output I/O execution unit which can intelligently manage incoming and outgoing data, comprising: at least one input/output controller for formatting data into a predetermined object data structure, and for sending a method invocation over an invocation network for indicating the availability of the object data to other execution units.

According to a eighth aspect of the present invention there is provided a computer system comprising an object orientated heterogeneous multiprocessor architecture of the first aspect of the invention as described above.

In a preferred embodiment the computer system comprises at least one of the devices of the fifth to seventh aspects of the invention described above.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the invention will now be described by way of example only, with reference to the drawings in which:

FIG. 1 is a schematic block diagram of a known object orientated system using symmetric multiprocessing;

FIG. 2 is a schematic block diagram of a known distributed object orientated system with multiple processors;

FIG. 3 is a schematic block diagram of an embodiment of an object orientated heterogeneous multiprocessor architecture of the present invention;

FIG. 4 is a block diagram showing the flow of messages passed between execution units during operation of an embodiment in accordance with the present invention;

FIG. 5 is a block diagram showing the flow of messages passed between two separate execution units that invoke one or more methods on different objects via a third common execution unit for an embodiment in accordance with the present invention;

FIG. 6 is a block diagram showing the flow of messages passed between execution units for synchronous and asynchronous method invocations in accordance with an embodiment of the present invention;

FIG. 7 is a block diagram showing the flow of messages between execution units for load balancing operation for an embodiment in accordance with the present invention;

FIG. 8 is a schematic block diagram showing a messaging interface connecting the invocation network to the execution units for an embodiment in accordance with the present invention;

FIG. 9 is a schematic block diagram showing the transfer of data to and from shared memory for a method forming part of a non-conglomerate object for an embodiment in accordance with the present invention;

FIG. 10 is a flow diagram showing the interaction of an object input data method with other object methods within an object orientated system in accordance with the present invention; and

FIG. 11 is a flow diagram showing the interaction of an output data method with other object methods during its execution in an embodiment in accordance with the present invention.

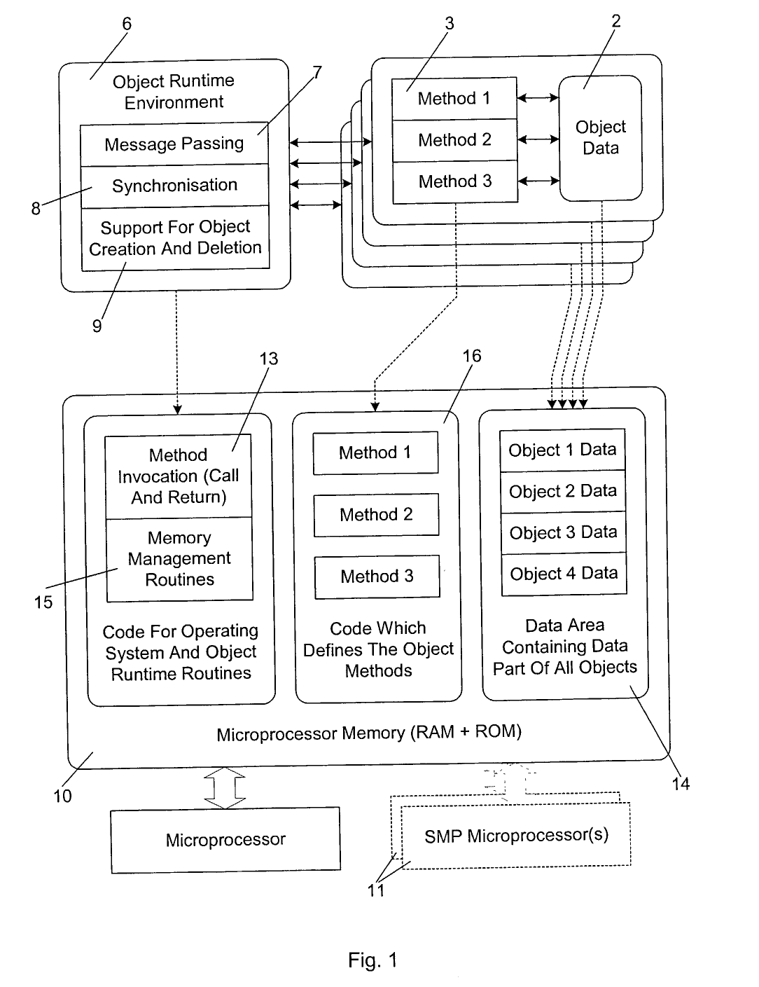

### DETAILED DESCRIPTION OF THE PREFERRED EMBODIMENTS

The invention is based around an object orientated structure. Each object is responsible for its own behaviour, and can be implemented on any of the available processing resources. Consequently the resulting solution is based around a single set of source files describing the classes, which is easier to understand, use, support, maintain and re-use. The architecture is inherently scalable, with increased performance being achieved by simply adding more object resources. A significant advantage afforded by this architecture is that the software source remains unchanged when the architecture is scaled, when new objects are added, or when objects are regenerated with a different constitution, for example if software based objects are changed to hardware based objects.

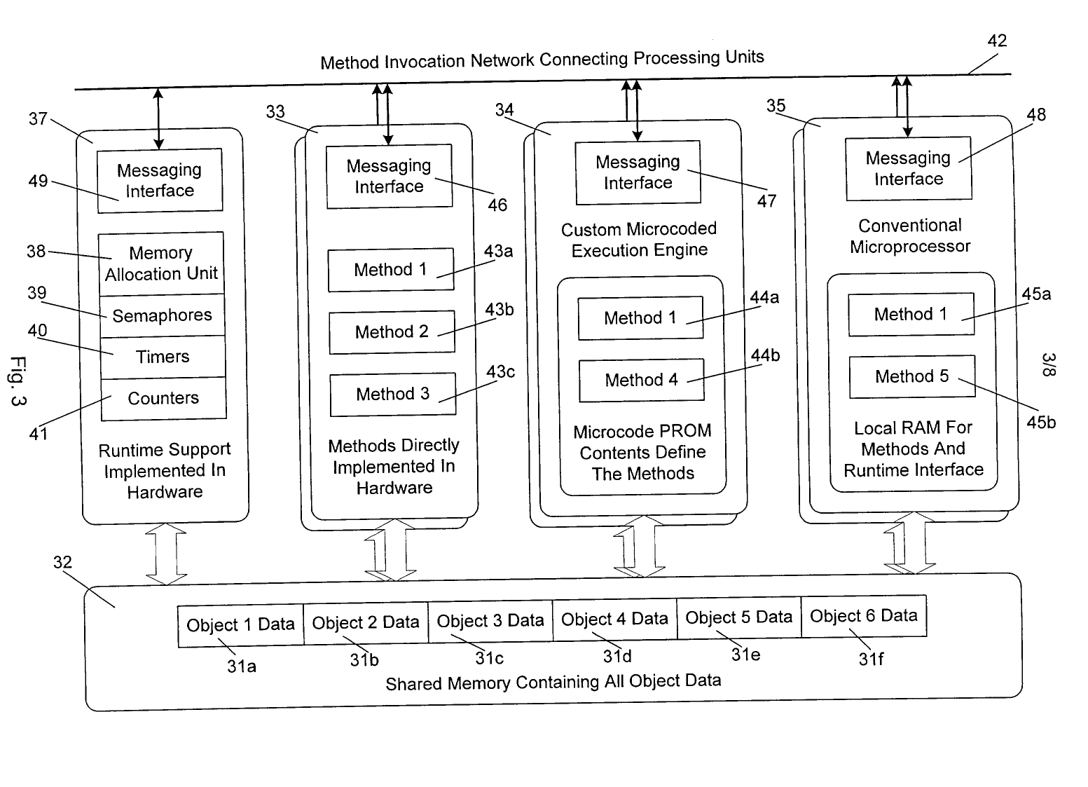

FIG. 3 shows an example of the way in which the objects are mapped onto the hardware components of a preferred embodiment, with object data 31a, 31b, 31c, 31d, 31e, 31f residing in shared memory 32 and object methods 43a, 43b, 43c, 44a, 44b, 45a, 45b distributed across a number of execution units 33, 34, 35, which may be conventional processors 35, custom microcoded engines 34 or direct hardware method implementations 33.

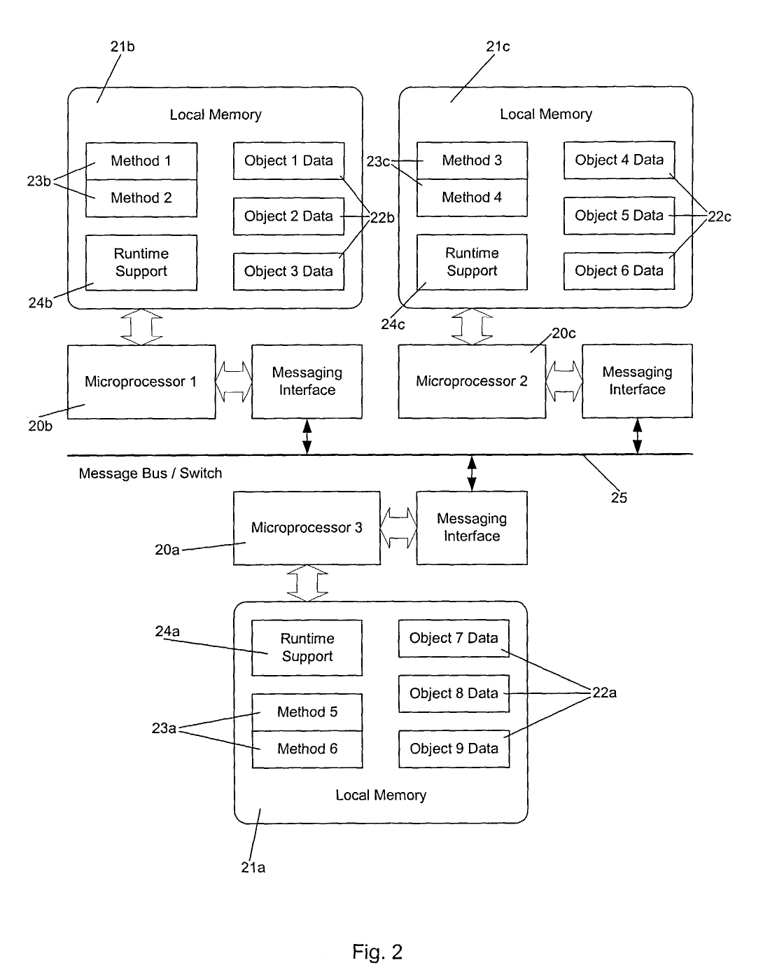

Objects where all elements of the object (data and methods) are bound together in one location i.e. not using shared memory are referred to as conglomerate objects, as shown in FIG. 2. Objects which are distributed across the system (i.e. using shared memory) are referred to as non-conglomerate objects, as shown in FIG. 3. A system of the form shown in FIG. 3 does not preclude the use of conglomerate objects.

A runtime support 37 as shown on the left hand side of FIG. 3, consists of a set of service objects that may take either conglomerate or non-conglomerate forms (i.e. conglomerate service objects or non-conglomerate service objects). The examples shown in FIG. 3 are conglomerate service objects, since all the methods and data are shown blocked together to give a memory allocation object 38, semaphores object 39, timers object 40 and counters object 41. In practice, these objects are also implementable as non-conglomerate service objects within the scope of the invention. Service objects may be implemented using any combination of execution units (hardware, microcoded engine or processor based).

As object methods 43a, 43b, 43c, 44a, 44b, 45a, 45b (non-conglomerate objects) are distributed between embedded processors 34, 35 and dedicated hardware 33, an invocation network 42 is provided to communicate between them. In object orientated systems there is very extensive communication between different objects (which may all be operating in parallel). To this end, any suitable messaging system such as collision detect multiple access busses, token busses, token rings, packet and cell switch matrices or wormhole routing switch matrices may be used to form the invocation network 42.

In contrast to existing message busses or switches, the message invocation network 42 shown in FIG. 3 is designed specifically for carrying method invocation messages between method implementations of both conglomerate and non-conglomerate objects distributed over multiple parallel execution units 33, 34, 35, 37.

Since the methods associated with a particular object may be distributed across a number of hardware or software blocks, the data needs to be stored such that it is quickly accessible to all the execution units. A number of mechanisms for implementing the shared memory subsystem will satisfy this criteria, including multiport memory controllers, multiport caches, distributed caches with cache coherency support or any combination of these techniques. The memory may be made accessible to the execution units 33, 34, 35, 37 via conventional busses, crosspoint switches, address interleaved multiple busses or any combination thereof.

In order to provide runtime support for the objects in the system, a number of additional services are required which are accessible to all objects in the system via the message invocation network 42 and which may be implemented either as dedicated hardware or as software tasks. Examples of such services include additional shared access runtime objects for memory management 38, synchronisation semaphores 39, timers 40, counters 41, error handling, exception handling and any combination thereof.

Invocation Network

The threads of execution in the system are passed between execution units as methods are invoked. The method invocation and any subsequent return both generate traffic on the invocation network 42.

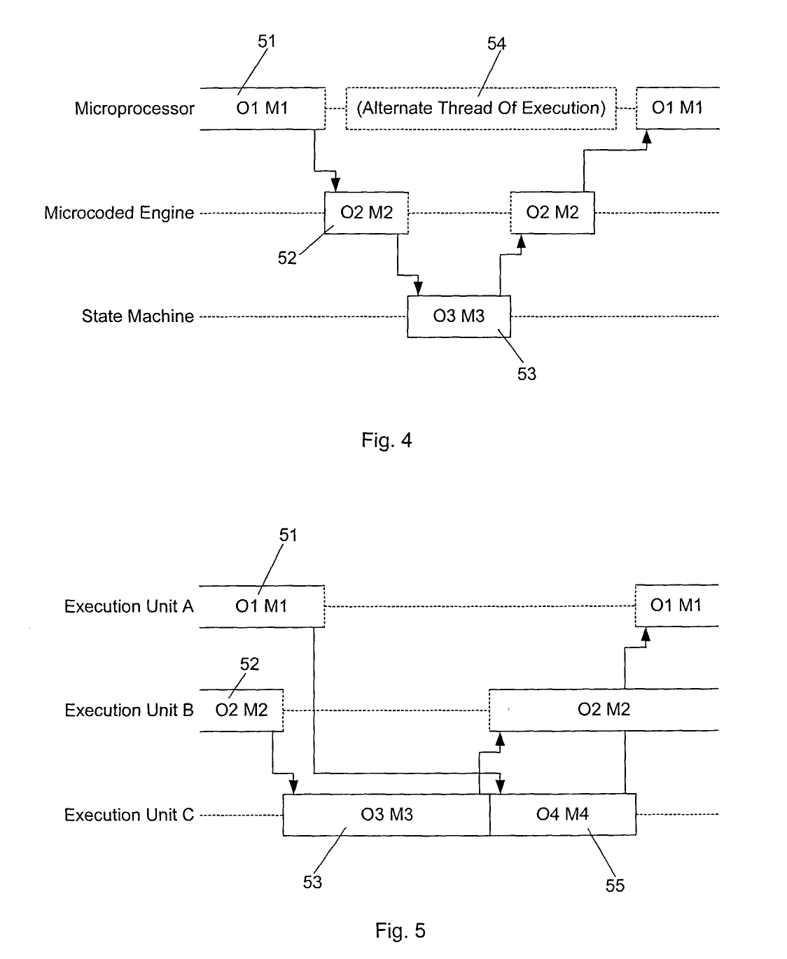

Examples of the way in which messages are passed between execution units 33, 34, 35, 37 are shown in FIGS. 4, 5 and 6, where the passed messages are indicated as black arrowed lines. The figures show active execution of individual execution units plotted against an arbitrary time axis.

The first example in FIG. 4 shows that method calls via the messaging interface 42 may be nested between execution units of different types. In this case, a method call is made from the thread of execution currently active on a processor component which corresponds to the execution of object 1 method 1 51. The method call invokes execution of object 2 method 2 52 on the microcoded engine, which in turn invokes the execution of object 3 method 3 53 on the hardcoded state machine. Note that there is no limitation on which types of execution unit may invoke methods on other execution units. It is perfectly viable for a state machine or microcoded engine to invoke a software method, or for any other combination of invoker and target method implementation to be used.

On completion, the state machine component returns a message to the microcoded engine. Similarly, the microcoded engine will also send a return message once object 2 method 2 52 has completed. The operating system on the microprocessor may support multitasking, in which case an alternate thread of execution 54 will have been scheduled after the initial method invocation. The return message will only be consumed once the alternate thread of execution has been suspended and the thread associated with object 1 method 1 51 restarted.

FIG. 5 shows the way in which two separate execution units may invoke one or more methods on different objects via a third common execution unit. In this case, execution unit B is initially running object 2 method 2 52, which passes a message to execution unit C in order to invoke object 3 method 3 53. Shortly afterwards, execution unit A attempts passing a message to execution unit C in order to invoke object 4 method 4 55. Since execution unit C is busy, this request is blocked until the execution of object 3 method 3 53 has completed.

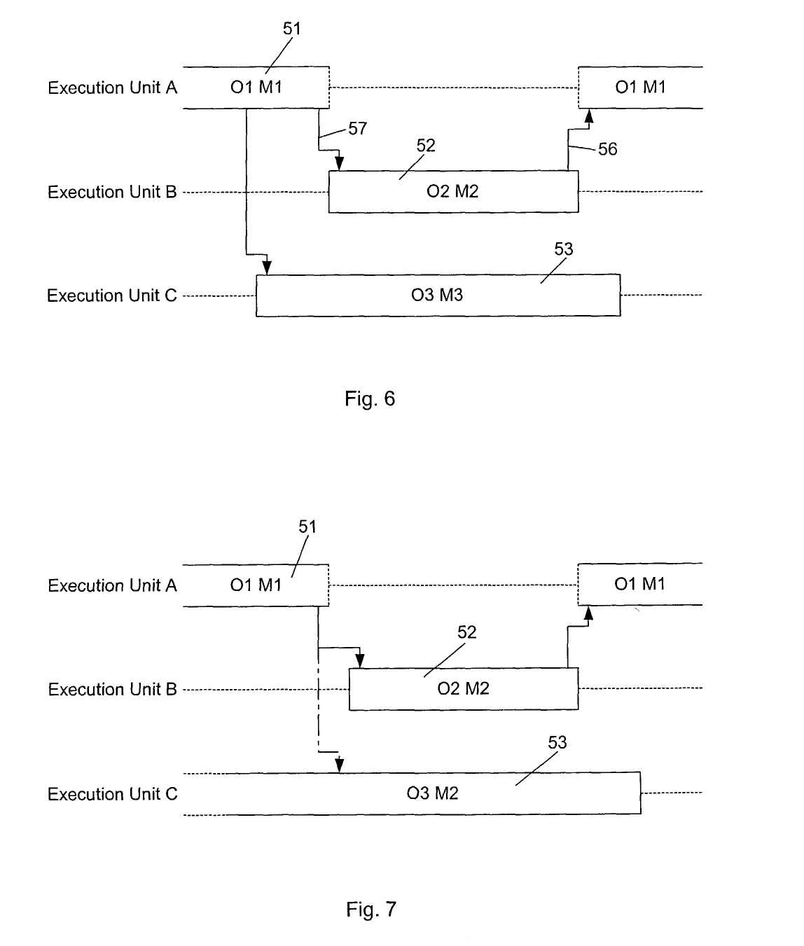

FIG. 6 illustrates the use of synchronous and asynchronous method invocations. The conventional mode of operation is for method invocations to complete with a return message, where execution of the calling method is suspended until the invoked method completes. This is illustrated by the way in which object 1 method 1 51 passes an invocation message 57 to object 2 method 2 52 and then execution unit A suspends until the return message 56 is received. The asynchronous mode of operation is illustrated by the invocation of object 3 method 3 53 on execution unit C. Here, execution on the invoking execution unit continues as soon as the message has been sent and no return message is passed back to the calling method.

The act of method invocation does not preclude the continued execution of the method on the invoking execution unit, nor does the sending of a return message preclude the continued execution of an invoked method on its execution unit.

Load Balancing

In some instances performance can be dramatically improved if multiple execution units are capable of executing the same method or set of methods on different objects of the same class. An example of load balancing operation is shown in FIG. 7. The invocation network 42 supports a mechanism whereby the messaging interface 46, 47, 48 of the invoking execution unit 33, 34, 35 can be provided with a range of execution unit targets which implement a given method.

In the event that the first choice target execution unit is busy, as is the case for execution unit C in the example shown in FIG. 7, any attempt to invoke the required method on that execution unit will be blocked. The invoking execution unit may then attempt to invoke the method on a secondary execution unit, as for execution unit B in the example. In the example, execution unit B is free, and object 2 method 2 52 will be invoked as required. If execution unit B should also be busy, the messaging interface 46, 47, 48 of the invoking execution unit will continue hunting through its list of viable targets. This system enables the transparent implementation of load balancing between the various execution units.

Message Interface

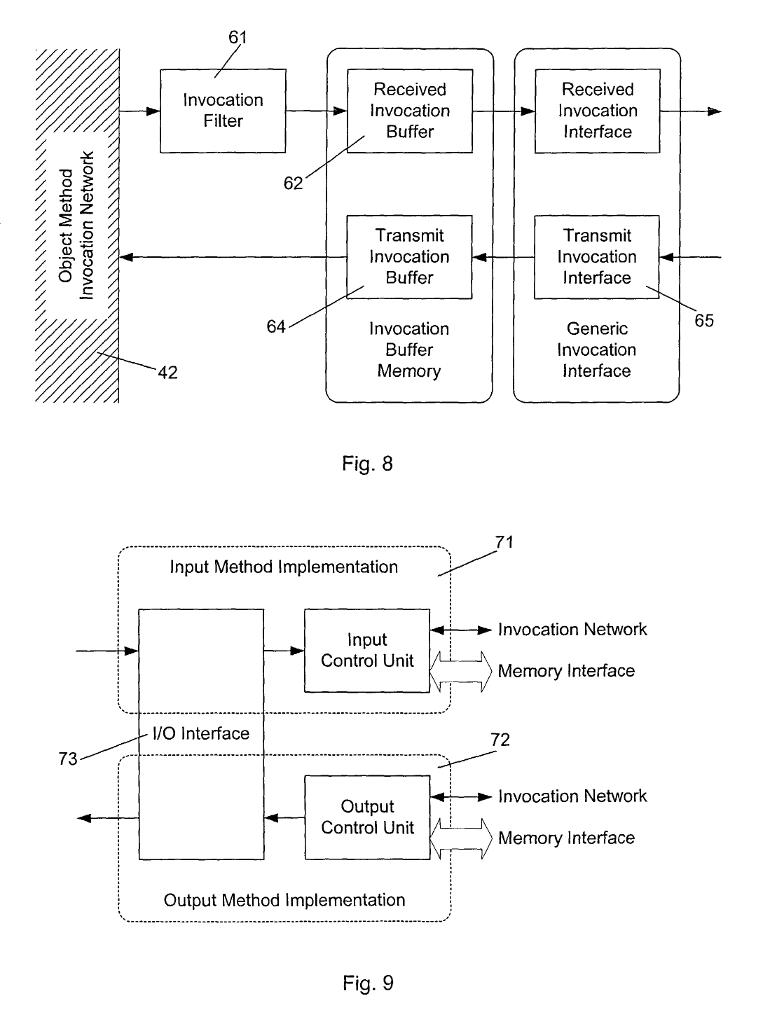

The message interface 46, 47, 48, 49 connects the messaging bus or switch fabric forming the invocation network 42 to the execution units 33, 34, 35, 37 in the manner shown in FIG. 8.

On the receive side, the interface is made up of a number of components. The filtering stage 61 selects messages for individual nodes, where each processing node is assigned a unique identifier either dynamically on start-up for software or hard-wired at manufacture for fixed blocks. The buffering stage 62 then acts as a temporary store for the message, thus freeing up the switch fabric, until the execution unit is ready to consume the received message. The execution unit can alternatively mark the node as being busy, which causes all incoming messages to be blocked.

The transmit path consists of a buffer 64 and controlling logic 65. The execution unit will generate a complete message and place it in the buffer. The control section will then attempt to send that message over the switch fabric. After the destination address is transmitted, the receiving node will signal back the acceptance or rejection (blocking) of the message. As previously described for message load balancing, messages can be rejected (blocked) if the receiving node is busy.

If the message is accepted, then the complete message is transmitted across the bus or switch. If the message is rejected, then repeated attempts will normally be made to transmit the message to the list of viable targets. If required, attempts to retransmit the message in this way may be aborted if a suitable target does not become available within a specified time. In this case, a higher level software entity may be notified in order to initiate any corrective action which may be required.

Shared Memory System

The shared memory 32 in this arrangement provides a common address space to all the execution units. All the execution units will potentially be running in parallel and all accessing shared memory, so the execution units use acknowledged memory transfers, and the shared memory system provides arbitration between the competing demands for memory bandwidth. A number of known examples of system-on-chip busses would be suited to this application.

Support For The Runtime Environment

There are a number of functions that the operating system traditionally performs that have high performance penalties. Specifically, memory allocation and event timers benefit greatly from a hardware accelerated approach. Additionally, programming semaphores are best centralised for efficient operation. These runtime support functions are provided as common resources connected to the hardware and software execution units via the on-chip invocation network 42.

Memory Allocation

A memory allocation unit 38 enables the shared memory 32 to be allocated to objects as and when required. Multiple memory areas may be employed for the total shared memory with each memory allocator 38 controlling allocation for a defined sub-area of the shared memory 32. The memory allocator 38 keeps track of the used and free memory space in ordered lists, changing each list depending on the requests for new memory or the release of used memory.

An object requiring an area of shared memory makes its request by passing a message detailing the amount of memory required to the memory allocator 38 which responds with a message detailing the position of the allocated memory space. By implementing the memory allocators 38 in hardware and interfacing to them over the invocation network 42, any object in hardware or software has the ability to create new object data areas 31a, 31b, 31c, 31d, 31e, 31f in shared memory 32.

The freeing of the shared memory is also handled by the runtime support, and as memory blocks are freed, known techniques for reducing memory fragmentation may be applied.

Event Timers

In event driven systems, it is important to be able to schedule multiple events at arbitrary times in the future. Hardware support for this which utilises the invocation network to inform objects of time-outs using call-back can improve performance.

Whilst in software systems, the number of timers which may be created is almost limitless, the resources required to service those timers can become excessive. Although hardware timers do not consume processor runtime resources, there is a cost associated with the hardware used to implement multiple physical timers that may or may not be required in the life time of the system.

The proposed arrangement addresses this issue by having a central hardware resource which does not consume software resources implemented in a software manner and providing an almost limitless number of timers 40. This component utilises the sending and receiving of messages as a mechanism to gain access to the timer functions.

The hardware resource is implemented as an ordered list of actions stored in local memory or a cached area of shared memory, where the availability of memory is the only limit to the number of timers that can be constructed. An action is created when the object requiring the timer functionality passes a message to the timer component and the action is then stored at the appropriate position in the ordered list. Each action has a unique identification which allows an individual object to maintain multiple timers.

When the timeout for an action occurs, a callback message is returned to the object which created the action, indicating that the timer has expired. Therefore the runtime resources required to implement a timer are minimised and the number of timers available to the system is only limited by the allocated memory.

Semaphores

Semaphores may be used in the system to protect particular object data 31 a, 31 b, 31c, 31d, 31e, 31f from corruption when multiple execution units 33, 34, 35 may be attempting to access object data at the same time. Although the use of semaphores is sometimes undoubtedly necessary, over reliance on semaphore synchronisation may imply that object abstraction or ordering is non-optimal.

Traditionally, semaphores have been implemented in multiprocessor systems by using atomic memory accesses to monitor and update semaphore flags in a shared memory area. However, with the various methods associated with the same object now communicating via an integrated messaging system i.e. the invocation network 42, implementing semaphores via hardware messaging is a more efficient and elegant approach.

Objects requiring access protection can request a new semaphore when they are created by sending a message to the semaphore manager 39. The new semaphore has a unique identification which is used by all methods which need to gain access to the protected data. Any object requesting access does so via a message to the semaphore manager 39 which specifies the unique semaphore identification.

A returning message grants access once the semaphore manager 39 has set the semaphore, thus denying access for other methods. If the semaphore is already set, the request is queued until the semaphore is released by the preceding requester. Once granted, semaphores must be released on completion of the critical section of execution by sending a release semaphore message. Semaphores must be removed via an appropriate message as the object which caused their creation is destroyed.

By using this central resource to construct, control and remove semaphores, any object methods implemented in either software or hardware may have controlled access to other object routines or data structures.

Counters

Conventionally, multiple counters have been implemented in either software or hardware within the same limitations as previously described for timers. In addition, since a number of counters can be used for gathering different statistical information, this information is normally accessed in counter groups—that is, related counter values should be requested or updated together in a contemporaneous manner. This avoids instances where one counter value may be processed whilst another related counter is being incremented, leading to inaccurate results. By implementing such counters as a central resource accessed via messages, all update or read operations from any method of any object can be implemented in an atomic manner.

Execution Units

The execution units 33, 34, 35, 37 are blocks that implement the message and shared memory interfaces and provide at least one object method implementation. The block must be capable of interpreting messages and returning acknowledgement messages as well as implementing the required method(s).

In many cases the execution unit will be implemented using a microcoded engine 34, processor 35 or other sequenced controller. However this is not a strict requirement and some method implementations may be based around state machines, pipelines or other fixed configurations 33. Such fixed configuration method implementations may be hardwired at the time of manufacture or implemented using embedded programmable logic such as programmable logic arrays (PLAs) or field programmable gate arrays (FPGAs).

When implementing methods on embedded processors, the interface between the software method definitions 45a, 45b and the hardware runtime support 37 may exist in a number of forms. At the most basic level, a set of libraries may provide a direct link between the software method(s) and the hardware runtime support. A more sophisticated software environment may use a real time operating system (RTOS) kernel with support for interrupt-driven multitasking to concurrently execute a number of methods. For a host processor running a fully featured operating system, this capability is extended such that conventional software applications may multitask alongside the executing methods.

A key feature of the proposed embodiments is the heterogeneous nature of the execution units, and the fact that they can all communicate together in a single system using the unified messaging and shared memory interfaces.

This provides overall system performance improvements, as signal processing methods can be implemented on dedicated digital signal processors (DSPs), network protocol based methods can be implemented on network processors and specialised tasks can be implemented using custom microcoded engines or directly in hardware. This ensures that there are no restrictions on how or where a method is implemented, allowing all method implementations to employ the best type of execution unit for their algorithmic properties.

Software Mapping

The process of mapping the high level description of the application is achieved using software tools to examine the application code and find within this code method invocations which refer to hardware accelerated methods or methods implemented on different execution units. These invocations are then modified to replace the standard calling mechanism with one that generates method invocation messages for sending across the invocation network 42.

This transformation may be implemented in a number of ways—the preferred approach is to perform the modifications at the link stage. The linker has access to the software method identifiers and method invocation parameters, and can use these to perform the necessary changes.

Alternatively dynamic linking could be implemented as part of the runtime environment.

Data I/O Method Implementations

Within the framework illustrated in FIG. 3, it is often necessary to provide object methods which are capable of transferring data from an external data input interface 71 to an object data area in memory or object data from memory to an external data output interface 72. Typically, the methods in question will form part of a non-conglomerate object as shown in FIG. 9 and they will perform the function of transferring data to and from shared memory 32. However, this does not preclude the implementation of an input/output I/O interface 73 on a conglomerate object whereby data is transferred to and from the local memory area of the relevant execution unit.

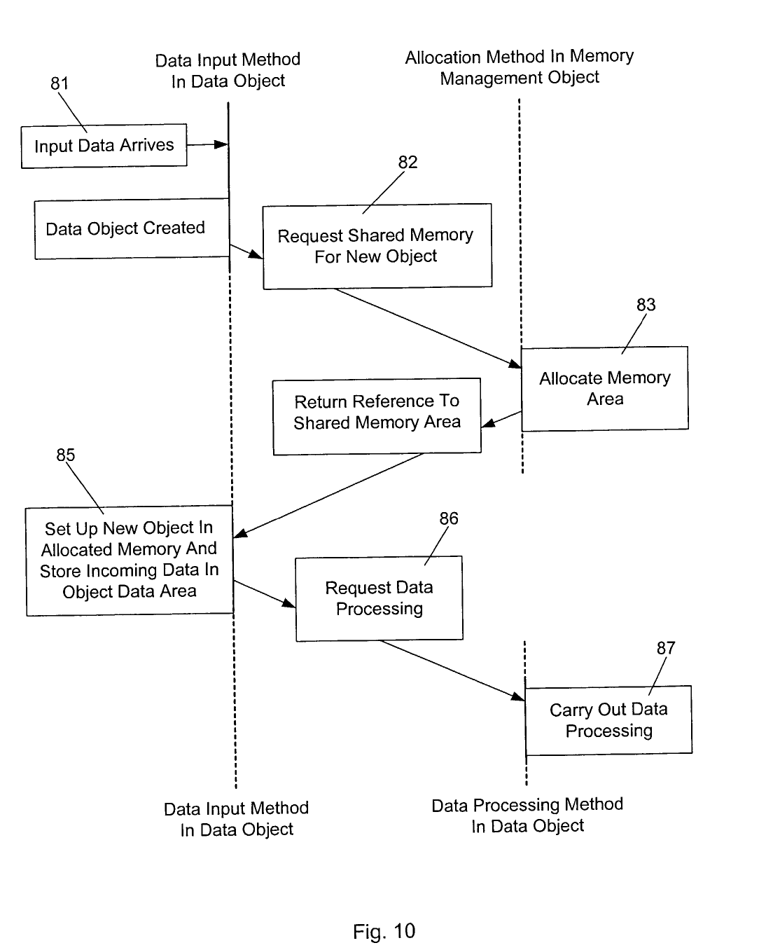

The way in which an object input method interacts with other object methods within the system is shown in FIG. 10. In this case, a thread of execution is initiated in the data input method by the arrival of an input data event 81. The type of this input data event is application specific, examples of which may be a data packet in communications systems, a sensor reading in control systems or a data sample in signal processing systems.

On receiving an input data event, the data input method behaves as a constructor method, requesting 82 a suitable area of shared memory for storage of the object data from the memory manager. Once the memory area has been allocated 83, the data input method sets up the memory area to be consistent with the requirements of the data object class and the input data is placed in the object data area 85, thus completing the object creation process. The data input method will then invoke 86 another method on the object in order to initiate the processing or other manipulation 87 of the object, according to the requirements of the system.

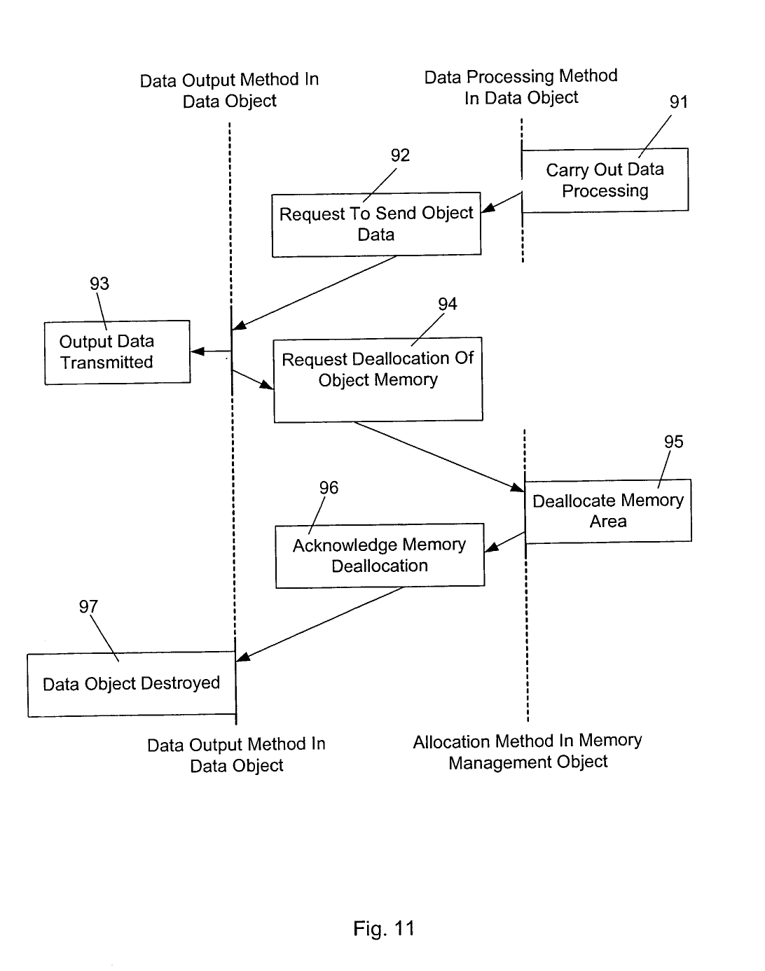

An example output data method is shown in FIG. 11, which is similar to the input data method previously described. Once a data processing method 91 has completed, and the data is ready for output, an output data method is invoked 92. Output data methods may be conventional methods which simply transmit the data part of the object 93 on the output port. Alternatively, they may be destructor methods which will automatically destroy the object once it has been transmitted.

In the example illustrated in FIG. 11, an output method which is a destructor method is shown. Once the output method is invoked, the data is transmitted 93 before the deallocate memory method is invoked 94 on the memory management object. This frees up 95 the memory area associated with the object so that it may be reused for the creation of new object data areas. Once memory deallocation has been acknowledged 96, the data output method has successfully destroyed 97 the object and the associated thread of execution is terminated.

It is not a requirement of the invention that messages be passed over a physically separate set of interfaces from the memory transactions, only that the method invocation mechanism is logically distinct from the mechanism used to access object data in the shared memory area. This encompasses implementations of the invention which provide physically separate method invocation and memory systems, a single combined multiplexed memory and invocation network and mechanisms whereby method invocation occurs via a logically distinct area of shared memory.

Also, a partitioned shared memory area may be used where there are multiple disjoint areas of shared memory each of which is only accessible to a subset of the total number of execution units within the system. The specific embodiment as described above being a special case whereby the number of shared memory areas is one.

Additionally load balancing and fault tolerance between processing objects can be achieved through monitoring not only the busy state of the target objects, but by using a more complicated matrix of parameters, such as average idle times, free threads, heartbeats or other indication of activity.

Although the invention has been shown and described with respect to a best mode embodiment thereof, it should be understood by those skilled in the art that the foregoing and various other changes, omissions and additions in the form and detail thereof may be made therein without departing from the scope of the invention as claimed.

1. An object orientated heterogeneous multiprocessor architecture comprising:
a plurality of execution units amongst which object methods are distributed;
a runtime support;
a shared memory for storing object data and which is accessible by the execution units and by the runtime support; and
an invocation network for carrying method invocation messages between execution units and between the runtime support, and any combination thereof, whereby object based source code is distributable across a variable number of execution units, and the invocation network is logically distinct from any mechanism for accessing the object data stored in the shared memory.

2. A multiprocessor architecture according to claim 1, wherein the architecture is implemented on a single integrated circuit.

3. A method of invoking an object method comprising:
passing a control message requesting the invocation of an object method on an object from a first execution unit to a second execution unit using an invocation network; and
executing the control message to invoke the object method on the object using the second execution unit.

4. A method of operating an object orientated heterogeneous multiprocessor architecture comprising:
concurrently activating a plurality of threads under the control of an application program; and
executing each of the plurality of threads by sequentially invoking a number of different object methods on a plurality of different execution units via an invocation network.

5. A method according to claim 4, wherein executing the object methods comprises one of: modifying, transforming and extracting object data held in the shared memory area.

6. A method according to claim 4, wherein sequentially invoking the plurality of object methods comprises:
accepting object method invocations from the invocation network; and
executing the object methods specified by the object method invocations as prescribed by the programming and configuration of the execution units.

7. A method according to claim 6, wherein executing the object methods comprises one of: modifying, transforming or extracting object data held in the shared memory area.

8. A method according to claim 4, wherein the plurality of threads are concurrently activated as a response to external events.

9. A method according to claim 8, wherein the step of executing the object methods comprises one of: modifying, transforming and extracting object data held in the shared memory area.

10. A method according to claim 8, wherein the step of sequentially invoking a plurality of object methods comprises:
accepting object method invocations from the invocation network; and
executing the object methods specified by the object method invocations as prescribed by the programming and configuration of the execution units.

11. A method according to claim 10, wherein the step of executing the object methods comprises one of: modifying, transforming and extracting object data held in the shared memory area.

12. A method of operating an object orientated heterogeneous multiprocessor architecture comprising the steps of:
concurrently activating a plurality of threads under the control of an application program; and
executing each of the plurality of threads by sequentially invoking a number of different object methods comprising the steps of:
passing a control message requesting the invocation of an object method on an object from a first execution unit to a second execution unit using an invocation network; and
executing the control message to invoke the object method on the object using the second execution unit.

13. A method according to claim 12, wherein the plurality of threads are concurrently activated as a response to external events.

14. A method of operating an object orientated heterogeneous multiprocessor architecture comprising: a plurality of execution units amongst which object methods are distributed; a runtime support; a shared memory for storing object data and which is accessible by the execution units and by the runtime support; and an invocation network for carrying method invocation messages between execution units and between the runtime support, and any combination thereof, whereby object based source code is distributable across a variable number of execution units, and the invocation network is logically distinct from any mechanism for accessing the object data stored in the shared memory,
said method comprising the steps of:
concurrently activating a plurality of threads under the control of an application program; and
executing each of the plurality of threads by sequentially invoking a number of different object methods on the plurality of different execution units via the invocation network.

15. A method according to claim 14, wherein the plurality of threads are concurrently activated as a response to external events.

16. A method of managing communication in an object orientated program execution environment comprising the steps of:
generating method invocations using execution units;
passing the method invocations over an invocation network; and
nesting method invocations between multiple execution units via a method invocation interface.

17. An invocation network capable of being used with the multiprocessor architecture of claim 1, comprising:
a messaging bus or switch for conveying control messages issued by execution units; and
a plurality of method invocation interfaces for connecting the messaging bus to the execution units.

18. An invocation network according to claim 17, wherein the multiprocessor architecture is implemented on a single integrated circuit.

19. A runtime support capable of being used with the multiprocessor architecture of claim 1, and having at least one object comprising:
at least one memory allocation unit, wherein the runtime support is provided as a collection of resources in communication with other hardware and software objects via an invocation network.

20. A runtime support according to claim 19, wherein each object further comprises one or more of: at least one counter, at least one event timer, and at least one semaphore.

21. A runtime support according to claim 20, wherein the multiprocessor architecture is implemented on a single integrated circuit.

22. An input/output I/O execution unit which can intelligently manage incoming and outgoing data, comprising:
at least one input/output controller for formatting data into a predetermined object data structure, and for sending a method invocation over an invocation network for indicating the availability of the object data to other execution units.

23. A computer system comprising an object orientated heterogeneous multiprocessor architecture comprising:
a plurality of execution units amongst which object methods are distributed;
a runtime support;
a shared memory for storing object data and which is accessible by the execution units and by the runtime support; and
an invocation network for carrying method invocation messages between execution units and between the runtime support, and any combination thereof, whereby object based source code is distributable across a variable number of execution units, and the invocation network is logically distinct from any mechanism for accessing the object data stored in the shared memory.

24. A computer system according to claim 23, wherein the multiprocessor architecture is implemented on a single integrated circuit.

25. A computer system according to claim 24, wherein the invocation network comprises:
a messaging bus or switch for conveying control messages issued by execution units;
a plurality of method invocation interfaces for connecting the messaging bus to the execution units.

26. A computer system according to claim 24, wherein the runtime support has at least one object comprising:
at least one memory allocation unit,
wherein the runtime support is provided as a collection of resources in communication with other hardware and software objects via the invocation network.

27. A computer system according to claim 26, wherein each object further comprises one or more of: at least one counter, at least one event timer, and at least one semaphore.

28. A computer system according to claim 24, wherein at least one of the execution units is an input/output I/O execution unit which can intelligently manage incoming and outgoing data and comprises:
at least one input/output controller for formatting data into a predetermined object data structure, and for sending a method invocation over an invocation network for indicating the availability of the object data to other execution units.
